(19) United States
(12) Patent Application Publication
(10) Pub. No.: US 2024/0084966 A1
(43) Pub. Date: Mar. 14, 2024

(54) SAFETY FENCING SYSTEM

(71) Applicant: SCIENTEC TECHNOLOGY PTE LTD, Singapore (SG)

(72) Inventor: Meng Fei LIM, Singapore (SG)

(73) Assignee: SCIENTEC TECHNOLOGY PTE LTD, Singapore (SG)

(21) Appl. No.: 17/766,862

(22) PCT Filed: Nov. 10, 2020
(86) PCT No.: PCT/SG2020/050645

§ 371 Date: Apr. 6, 2022

(30) Foreign Application Priority Data
Nov. 28, 2019 (SG) 10201911329W

(51) Int. Cl. F16P 3/14; G01S 5/02; G01S 7/00; G01S 7/41; G01S 13/42; G01S 13/87; G01S 13/88; H04W 4/021

(52) U.S. Cl. CPC F16P 3/147; G01S 5/0289; G01S 7/003; G01S 7/415; G01S 13/42; G01S 13/872; G01S 13/886; H04W 4/021; G01S 13/74

(57) ABSTRACT

A fencing node (2) for a safety fencing system (1) defining a fencing area, including; a distance measurement device (5) for measuring distances between at least two other adjacent said fencing nodes to thereby determine the fencing area, an object detection device for detecting one or more objects located within and/or around the fencing area, and a microprocessor system (7) for processing data from the distance measurement devices and the object detection devices of a plurality of said fencing nodes, the microprocessor system determining a shape and dimensions of the fencing area based on the data received from the distance measurement devices, and a relative location of the or each detected object within and/or around the fencing area on data received from the object detection devices, wherein the object detection device is an object detection transceiver (3) for sending radio signals through the fencing area, and for measuring radio signals reflected from the or each detected object to thereby determine a distance and angular position of the or each said detected object relative to the fencing node.

### FIELD

The present invention relates to safety fencing systems. While the present invention will be described in relation to its use in industrial applications, it is to be appreciated that the present invention is not limited to this application, and that other applications such as in security, in public area queuing lanes or exhibition areas are also envisaged.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Physical safety fencing can be used in industrial applications to both define a fencing area within which only authorised workers can be present, or to restrict entry into that fencing area. A disadvantage of such physical fencing is that it is not always possible or practical to install such fencing within an industrial area such as a building or manufacturing site. Such fencing also takes time to set up in situations which allow for such fencing to be installed. Furthermore, there is generally no means to monitor the entry or exit of persons to or from the area being fenced, or to monitor humans and other objects within the fencing area. There are also generally no means provide any warning when an unauthorised person enters that fencing area.

It would therefore be advantageous to be able to provide a fencing system without the need for physical fences, and with minimal setting up required.

An alternative is an ‘invisible’ fencing system which uses electronic means to designate a fence surrounding a predefined area. Such a system is for example described in U.S. Ser. No. 10/084,556b1 (Young et al) directed to an invisible fence for pets that requires the pet to wear a radio linked collar unit for communicating with a signal generating unit of the invisible fence system, and for controlling the pet so that it remains confined within an area enclosed by the invisible fence.

It would however be advantageous to having a safety fencing system that can operate without the need for any communication device to be carried by a person, pet or object within the fencing area.

An object of the invention is to ameliorate one or more of the above-mentioned difficulties.

### SUMMARY

According to an aspect of the present disclosure, there is provided a fencing node for a safety fencing system defining a fencing area, including; a distance measurement device for measuring distances between at least two other adjacent said fencing nodes to thereby determine the fencing area, an object detection device for detecting one or more objects located within and/or around the fencing area, and a microprocessor system for processing data from the distance measurement devices and the object detection devices of a plurality of said fencing nodes, the microprocessor system determining a shape and dimensions of the fencing area based on the data received from the distance measurement devices, and a relative location of the or each detected object within and/or around the fencing area on data received from the object detection devices, wherein the object detection device is an object detection transceiver for sending radio signals through the fencing area, and for measuring radio signals reflected from the or each detected object to thereby determine a distance and angular position of the or each said detected object relative to the fencing node.

In some embodiments, the microprocessor system may differentiate the or each detected object as a human or as an inanimate object based on movement of the object.

In some embodiments, the fencing system may further include a radio communication transceiver, wherein the microprocessor system issues an alert signal through the radio transmission transceiver under specific conditions based on information provided by said data. The specific conditions may be the movement of a detected said human out of the fencing area. Alternatively, the specific conditions may be the movement of a detected said human into the fencing area. The alert signal may be provided by an alert sounder device. Alternatively, the alert signal may be provided by an SMS/message sender.

In some embodiments, the radio communication transceiver may be adapted to identify humans carrying identification devices that indicate their authorization to enter or exit or be within the fencing area. The identification device may be a smart phone or watch, long range radio, GNSS device or RFID tag.

In some embodiments, the radio communication transceiver may be adapted to send the alert signal to radio communication transceivers supported on objects located within and/or around the fencing area.

In some embodiments, the radio communication transceiver may be adapted to send a control signal for controlling an operation of machinery detected as said object within and/or around the fencing area. The control signal may slow or stop the operation of the machinery.

In some embodiments, the distance measurement device may be a distance measurement transceiver for sending radio signals to adjacent said fencing nodes to thereby ascertain the distances therebetween.

According to another aspect of the present disclosure, there is provided a safety fencing system for defining a fencing area and for detecting one or more objects located within and/or around the fencing area, including at least three fencing nodes as described above locatable in a spaced apart relationship around a periphery of the fencing area, and optionally within the fencing area.

According to a further aspect of the present disclosure, there is provided a method of using a safety fencing system as described above; the method including locating the fencing nodes in a spaced apart relationship around a periphery of the fencing area and optionally within the fencing area, activating the distance measurement device of each said fencing node to send a radio signal to adjacent said fencing nodes for ascertaining a distance between the fencing nodes to thereby determine a shape and dimensions of the fencing area, and activating the object detection device of each fencing node to send radio signals within and/or outside the fencing area, to measure radio signals reflected from the or each detected object to thereby determine a distance and angular position of the or each said detected object relative to the fencing node. In some embodiments, the method may include determining distances between the detected objects.

In some embodiments, the method may include tracking movement of the detected object.

In some embodiments, the method may include identifying the detected object as a human based on movement thereof.

In some embodiments, the method may include counting the number of detected humans within and/or outside of the fencing area.

In some embodiments, the method may include providing an alert signal when the distance between the detected objects/humans is below a predetermined value.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, an embodiment of the present disclosure,

FIG. 1 is a schematic view of a safety fencing system according to an embodiment of the present disclosure; and

FIG. 2 is flow chart showing the operation of the safety fencing system as shown in FIG. 1.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

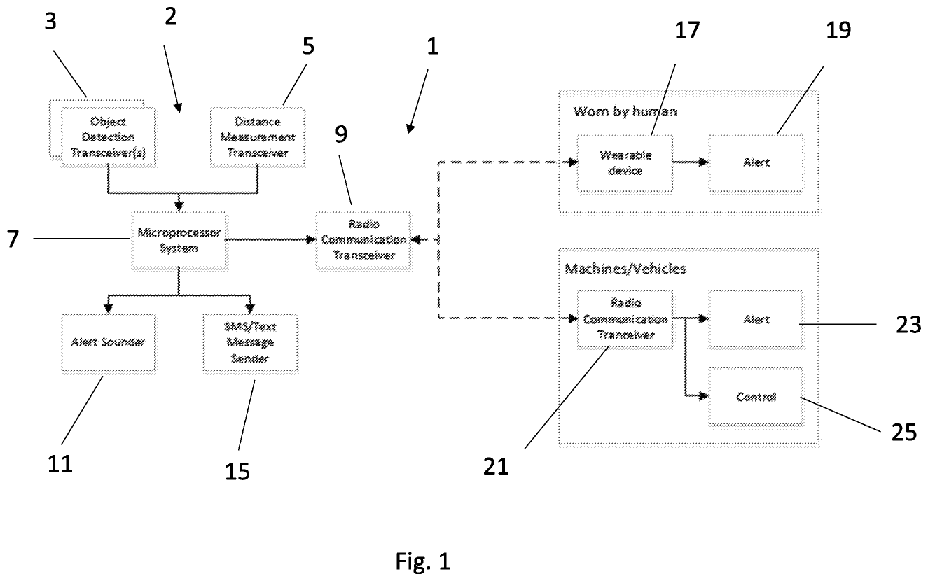

Referring initially to FIG. 1, there is shown various components of a safety fencing system according to an embodiment of the present disclosure. That system 1 requires at least three fencing nodes 2 to operate. The fencing nodes 2 are located and spaced apart at or adjacent the periphery of an area being fenced by the fencing system 1. The location of the fencing nodes therefore defines the fencing area to be covered by the fencing system using triangulation. Therefore, three fencing nodes 2 can define a triangular shaped fencing area, while four fencing nodes 2 can define a quadrilateral shaped fencing area. Each node 2 includes a distance measurement device in the form of a distance measurement transceiver 5 for sending radio signals to the distance measurement transceiver 5 of adjacent nodes 5 to thereby ascertain the distance between the distance measurement transceiver 5 transmitting the radio signal, and the distance measurement transceiver 5 receiving that signal. The measured distances between the distance measurement transceiver 5 of each node 2 can then be used to determine the shape and dimensions of the fencing area using triangulation without the need for any configuration, calibration of setting that may be required with other types of devices.

Each fencing node 2 further includes an object detection device in the form of an object detection transceiver 3 that are used to locate the position of objects within the fencing area. Each object detection transceiver 3 periodically sends a radio signal through and/or around the fencing area which can reflect from any object(s) located within and/or around the fencing area. The reflected radio signals can be received and measured by the object detection transceiver 3 to determine the distance and angular position of that object from the object detection transceiver 3 as well as the relative position of that object from the transceiver 3. The measurement from each of the object detection transceivers 3 may then be transmitted to adjacent fencing nodes 2 via a radio communication transceiver 9 and collected to thereby allow for the angular position correction of the object measurements to thereby the determine the absolute position of that object within and/or around the fencing area relative to each fencing node 2 by using triangulation. This is because the object detection transceiver 3 can be facing any angular position, and that it is necessary to correct the angular position of each fencing node 2 by combining the relative position information using triangulation to thereby obtain the absolute position of the detected object. It is also envisaged that the distance measurement transceiver 5, rather than the radio transmission transceiver 9, be used to also transmit positional data to other fencing nodes 2 as it is already in communication with them.

The data from both the distance measurement transceiver 5 and object detection transceiver 3 may be processed by a microprocessor system 7 within the fencing node 2. That microprocessor system 7 may also allow for the differentiations of the detected objects into humans and other objects. This may for example be achieved by detecting whether the detected object is moving or not. Moving objects, for example due to body and breathing motion of a human, can identify humans, while inanimate objects will generally not be moving, and will therefore be determined to be not human.

In work situations, humans may be authorized to enter or exit or work within the fenced area. This may be achieved by having each authorized person wearing or carrying and identification device 17 such as, for example, a smart phone or watch, long range radio, GNSS device or RFID tag. The radio communication transceiver 9 of each or at least one of the fencing nodes 2 may be used for detecting the presence of such an identification device 17 so that the human can be identified as being authorized to be within or to be entering or exiting the fencing area. This also allows for the identification of humans entering or exiting the fencing area that are not authorized to be there because they will not be wearing an identification device.

Each or at least one fencing node 2 may be provided with an alert sounder 11 and/or an SMS/text message sender 15. The alert sounder 11 can for example emit a warning sound when a human is detected leaving or entering the fencing area, or when an unauthorized human enters or leaves that fencing area. An alert 19 in the form of, for example, a warning signal and/or SMS/text message may also be transmitted to the identification device 17 of a work supervisor, or each authorized person, to for example advise them that they are leaving or entering a fencing area or to let them know the presence of an unauthorized person in and/or around the fencing area. It is to be emphasized that the use of an identification device is optional and that the safety fencing system according to the present disclosure may still operate without such identification devices being carried. The position of any humans within the fencing area can still be identified, even if is not possible to determine whether that human is authorized to be within and/or around the fencing area, or to send any alert signal to that human.

Machines or vehicles entering and leaving the fencing area may also be provided with a radio communication transceiver 21 in communication with the radio communication transceiver 9 of the or each fencing node 2. The former radio communication transceiver 21 may also receive alerts from the or each fencing node 2 as they are moved into or out of the fencing area. Furthermore, the radio signal from the fencing node(s) 2 to the radio communication transceiver 21 may communicate with a control module 25 for controlling the machine/vehicle. That control module 25 may for example slow or stop the movement of the machine/vehicle when it enters or leaves the fencing area.

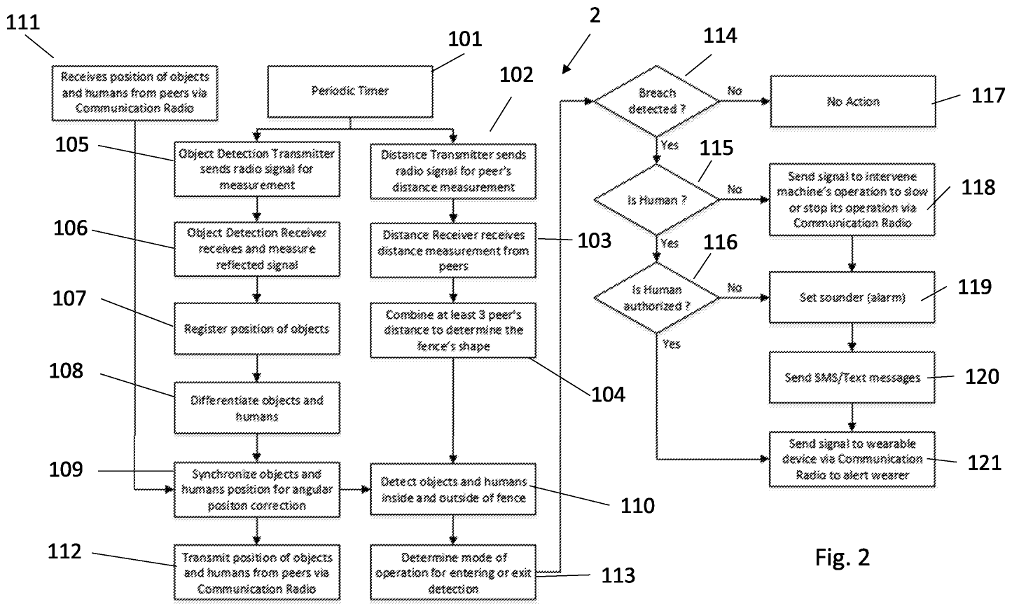

FIG. 2 is a flow chart showing the operational sequences of the safety fencing system 1 according to the present disclosure. A periodic timer (101) ensures that the distance measurement transceiver 5 and object detection transceiver 3 of each fencing node 2 periodically transmit radio signals therefrom. In the case of the distance measurement transceiver 5, radio signals are periodically transmitted (102) to allow for the distance between each fencing node 2 to be measured. Each distance transceiver 5 receives radio signals from each of the adjacent fencing nodes 2 identifying the measured distance therebetween (103). This information can then allow for the shape and dimensions of the fencing area to be determined (104). The object detection transceivers 3 also periodically transmits radio signals into and/or around the fencing area (105), and receives and measures any reflected radio signals from objects located within and/or around the fencing area (106). This can then determine the distance and angular position of that object away from the object detection transceiver (107). Any detected movement of the object can then allow for the differentiation of the object between humans that are moving, and other inanimate objects within and/or around the fencing area (108). The distance data from each object detection transceiver 3 can then be synchronized to allow for the correction of the angular position of each detected object relative to each fencing node 2 (109). This corrected angular positional data is then transmitted via the radio communication transceiver 9 to each of the other fencing nodes 2 (112). This positional data of each detected human/object can also be processed with the fencing data information obtained by the distance measurement transceivers 5 to obtain the relative position of the detected human/object within and/or around the fencing area (110). This can then allow for the movement of humans and other objects entering or exiting the fencing area to be tracked (110). A series of different actions may then be selected from the detection of these detected entry to or exits from the fencing area (113). It is initially determined where a breach of an object entering or exiting the fencing area is detected (114). When no breach is detected, the safety fencing system 1 takes no action (117). However, if a breach is detected, then it is determined whether the breach is by a human or not (115). If the breach is not by a human but is instead by a machine, then a control signal may be transmitted to a machine via its radio communication transceiver 21 to slow or stop the operation of that machine. If the breach is by a human, then it is determined whether that human is authorized to enter or exit or be within the fencing area (116). If that human is not authorized, then a warming alarm may be emitted to warn that human that they are in a potentially hazardous area (119). A warning SMS/text message may also be sent to a work supervisor to advise them of the presence of an unauthorized person on site (120). If the human is authorized, a warning signal is sent to the identification device of that authorized human to alert them of the breach (121).

The safety fencing system 1 according to the present disclosure can therefore determine the absolute position of any object/human within or outside of the fencing area at a specific time. The detectable area outside of the fencing area will be dependent on the radio signal strength of each of the fencing nodes 2. As the position of each object/human is being periodically determined, this enables the safety fencing system 1 to track the change in position of objects/humans within and/or outside of the fencing area. Furthermore, the distance between different objects/humans can also be determined once the position of each object/human is determined. This then also allows for changes in the distances between different objects/humans to be tracked. A warning signal/alarm may be set off by the safety fencing system 1 if the distance between different objects/humans is below a predetermined value. For example, the distance between different humans may be tracked, and an alarm may be set off if the distance between an object or human, or between two humans is too close. This can be achieved without the need for any tagging device being carried by the human while within the fencing area. In these case of machinery detected as objects within the fencing area, a visual or audio warning and/or a slow and stop control signal may be sent to the machinery found to be too close to a human or other object. It is also envisaged that machinery working within the fencing area be provided with a display unit, for example within the machinery driving cabin, displaying the location of humans within and/or outside the working area based on information provided by the safety fencing system 1.

The fencing system 1 according to the present disclosure also allows for the number of humans within or outside of the fencing area to be detected. This then means that the number of humans within or outside of the fencing area can be counted at any time. The detectable area outside of the fencing area will be dependent on the radio signal strength of each of the fencing nodes 2. This ability to detect the number of humans inside outside the fencing area will allow the safety fencing system 1 to generate a statistic report of human numbers, or provide a warning, for example when overcrowding is detected.

In situations where the area to be fenced is large, it may be necessary to deploy a greater number of fencing nodes 2 around the boundary of the fencing area to allow that area to be covered. However, there may be situations where the centre area of the fencing area is outside the radio coverage of the fencing nodes 2 deployed along the boundary of the fencing area. It may therefore be necessary in these situations to deploy one or more further fencing nodes 2 within the fencing area to thereby form a set of nodes instead of a boundary shape to complete the coverage. These additional fencing nodes 2 within the fencing area can be automatically detected as inner nodes once they are deployed within the fencing area.

It should be appreciated by the person skilled in the art that the above invention is not limited to the embodiment described. It is appreciable that modifications and improvements may be made without departing from the scope of the present invention. For example, the distance measurement device may alternatively be a GNSS device, while the object detection device may alternatively be a camera. Such devices can also use a triangulation method that eliminates the configuration and calibration process in order to make the deployment and commissioning process as efficient as possible. It is also possible for the safety fencing system to only include distance measuring devices within the fencing nodes, without the object detection devices. The distance measurement devices can still operate to define the shape and absolute position of the fencing area, and this information can be transmitted to vehicles/machines/humans so that a decision can be made on whether or not to keep in or out of the fencing area.

It should be further appreciated by the person skilled in the art that one or more of the above modifications or improvements, not being mutually exclusive, may be further combined to form yet further embodiments of the present invention.

1. A fencing node for a safety fencing system defining a fencing area, including; a distance measurement device for measuring distances between at least two other adjacent said fencing nodes to thereby determine the fencing area, an object detection device for detecting one or more objects located within and/or around the fencing area, and a microprocessor system for processing data from the distance measurement devices and the object detection devices of a plurality of said fencing nodes, the microprocessor system determining a shape and dimensions of the fencing area based on the data received from the distance measurement devices, and a relative location of the or each detected object within and/or around the fencing area on data received from the object detection devices, wherein the object detection device is an object detection transceiver for sending radio signals through the fencing area, and for measuring radio signals reflected from the or each detected object to thereby determine a distance and angular position of the or each said detected object relative to the fencing node.

2. The fencing node according to claim 1, wherein the microprocessor system differentiates the or each detected object as a human or as an inanimate object based on movement of the object.

3. The fencing node according to claim 2, further including a radio communication transceiver, wherein the microprocessor system issues an alert signal through the radio transmission transceiver under specific conditions based on information provided by said data.

4. The fencing node according to claim 3, wherein the specific conditions is the movement of a detected said human out of the fencing area.

5. The fencing node according to claim 3, wherein the specific conditions is the movement of a detected said human into the fencing area.

6. The fencing node according to claim 3, wherein the alert signal is provided by an alert sounder device.

7. The fencing node according to claim 3, wherein the alert signal is provided by an SMS/message sender.

8. Tre fencing node according to claim 3, wherein the radio communication transceiver is adapted to identify humans carrying identification devices that indicate their authorization to enter or exit or be within the fencing area.

9. The fencing node according to claim 8, wherein the identification device is a smart phone or watch, long range radio, GNSS device or RFID tag.

10. The fencing node according to claim 3, wherein the radio communication transceiver is adapted to send the alert signal to radio communication transceivers supported on objects located within and/or around the fencing area.

11. The fencing node according to claim 3, wherein the radio communication transceiver is adapted to send a control signal for controlling an operation of machinery detected as said object within and/or around the fencing area.

12. The fencing node according to claim 11, wherein the control signal slows or stops the operation of the machinery.

13. The fencing node according to claim 1, wherein the distance measurement device is a distance measurement transceiver for sending radio signals to adjacent said fencing nodes to thereby ascertain the distances therebetween.

14. The safety fencing system for defining a fencing area and for detecting one or more objects located within and/or around the fencing area, including at least three fencing nodes according to claim 1 locatable in a spaced apart relationship around a periphery of the fencing area, and optionally within the fencing area.

15. A method of using a safety fencing system according to claim 14; the method including locating the fencing nodes in a spaced apart relationship around a periphery of the fencing area and optionally within the fencing area, activating the distance measurement device of each said fencing node to send a radio signal to adjacent said fencing nodes for ascertaining a distance between the fencing nodes to thereby determine a shape and dimensions of the fencing area, and activating the object detection device of each fencing node to send radio signals within and/or outside the fencing area, to measure radio signals reflected from the or each detected object to thereby determine a distance and angular position of the or each said detected object relative to the fencing node.

16. The method according to claim 15, including determining distances between the detected objects.

17. The method according to claim 15, including tracking movement of the detected object.

18. The method according to claim 15, including identifying the detected object as a human based on movement thereof.

19. The method according to claim 18 including counting the number of detected humans within and/or outside of the fencing area.

20. The method according to claim 18 including providing an alert signal when the distance between the detected objects/humans is below a predetermined value.
